(19) United States
(12) Patent Application Publication
(10) Pub. No.: US 2009/0048908 A1
(43) Pub. Date: Feb. 19, 2009

(54) MEDIA DELIVERY SYSTEM

(75) Inventors: Robert E. Kaplan, Mercer Island, WA (US); Stuart Graham, Kenmore, WA (US); Mars Tanumihardja, Seattle, WA (US); Ajay Arora, Boston, MA (US); Johann Garcia, Kirkland, WA (US); Prasantha Jayakody, Seattle, WA (US)

Correspondence Address: Kimton N. Eng, Esq.;DORSEY & WHITNEY LLP, Suite 3400, 1420 Fifth Avenue, Seattle, WA, 98101, US

(73) Assignee: Vulcan Portals, Inc., Seattle, WA (US)

(21) Appl. No.: 12/257,161

(22) Filed: Oct. 23, 2008

Related U.S. Application Data
(63) Continuation-in-part of application No. 11/981,636, filed on Oct. 30, 2007.
(60) Provisional application No. 60/898,855, filed on Jan. 31, 2007.

(51) Int. Cl. G06F 17/30

(52) U.S. Cl. 705/10

(57) ABSTRACT

A media delivery system that may be used for tracking the number and type of human impressions of media content rendered by the system during the time the media was rendered is provided. The media delivery system includes a rendering device for rendering media content, an environmental sensor for sensing impressions and other environmental variables and a computing device configured to gather data related to the external states detected by the environmental sensor. The data may be provided to a backend server for correlating the data to the rendered media content. The system may include rules that interpret that data and may cause the system to custom select, tailor or control future playback of media on the system.

### RELATED APPLICATION DATA

This application is a continuation-in-part of and claims priority to U.S. Nonprovisional patent application Ser. No. 11/981,636, entitled BACK-CHANNEL MEDIA DELIVERY SYSTEM, filed Oct. 30, 2007, which claims priority to U.S. Provisional Patent Application Ser. No. 60/898,855, entitled BACK-CHANNEL MEDIA DELIVERY SYSTEM, filed Jan. 31, 2007, which applications are incorporated herein by reference.

### TECHNICAL FIELD

The present invention relates to techniques for rendering media content on a media delivery device that tracks human impressions of the media content, as well as other environmental data, during the time it was rendered by the media delivery device.

### BACKGROUND OF THE INVENTION

It has always been difficult for advertisers to gauge the effectiveness of their advertisements particularly where the advertising is done through traditional modes of advertising such as television or newspaper. Generally speaking, television networks and newspaper publishers have only approximate statistics on the number of viewers or readers within a given market. Newspaper publishers, for example, can approximate the number of newspapers that are read on any given day based on subscription and other sales data. Of course, every person who receives a newspaper is not going to read every advertisement within that paper. Consequently, newspaper publishers and those who purchase advertisements from the publishers have only a loose idea of how many people are exposed to or actually read their advertisements. Likewise with television advertising, the viewership of any given program, and the commercials that run during such programs, is not known with precision. The so-called ‘ratings’ for television programs are gathered statistically and again, calculating the number of people who are reached with any given advertisement is imprecise. Ideally, advertisers would like more substantive feedback about who and how their advertising content is being viewed.

With the rise of Internet advertising, advertisers are given more direct and immediate feedback on who is viewing their advertisements. Suppose, for example, that an advertiser purchases advertisements on the website of a major internet search engine such as Google. The advertisement provider, Google in this case, gathers data on the precise number of times that a given advertisement is actually rendered during a page view. Likewise, the advertisement provider can gather data representing the precise number of times a given advertisement is actually clicked by the viewer of the advertisement. Such feedback is invaluable because it allows advertisers to get feedback on the exact, rather than approximate, number of impressions the advertising made on the target audience. An “impression” results from a person perceiving an advertisement. In the context of a newspaper, an advertisement has an impression every time a person turns to the page of the paper where the advertisement is located. Since it is not possible to know with any certainty what pages of a newspaper are every actually viewed by a person, it is not possible to know with any certainty how many impressions a newspaper-based advertisement receives. A similar problem exists with television advertising because, as was discussed above, television ‘ratings’ are statistical estimates and calculating the number of people reached with any given advertisement is imprecise.

In addition to impression information, the feedback provided by an internet advertisement provider such as Google also provides valuable information about how effective an internet-based advertisement is in generating an inquiry (i.e. it tells you how many impressions actually result in a click on the advertisement). Data can be generated by, and fed back from an advertising channel. This type of data has increasingly become the currency driving Internet advertising business. Absolute measurement—vs. statistical analysis—is key to advertisers, corporate and content programmer confidence.

Although television, newspaper and magazine advertising channels continue to be very important, other forms of advertising such as audio, video and electronic signage in retail spaces, hotels, restaurants and other public places are becoming increasingly prevalent. Such advertising media might comprise playback of DVD's, computer generated media or animation, media system manager video and audio, satellite dish video, streaming internet protocol television (‘IPTV’), still pictures, or even audio. Some such systems have the capability to report on what media content was played at what time and to schedule the time at which particular media is played. While these are very valuable controls for advertisers who wish to control their messaging, there is currently no mechanism for reporting how many people were or are exposed to an impression of such media content. Likewise, there is no mechanism for adapting the media content to account for local variables and conditions detected during media playback.

There is therefore a need for an media delivery system that gathers data about the number and type of human impressions of media content delivered by a content rendering device for cross-correlation of such impression data with the media content. Such a system may also alter the media content it delivers based on such data.

### BRIEF DESCRIPTION OF THE DRAWINGS

FIGS. 1A and 1B are block diagrams of example embodiments of media delivery systems. FIG. 1C is a block diagram of a media delivery system according to an embodiment of the invention.

FIGS. 2A-2C are data flow diagrams of operation of example embodiments of media delivery systems.

FIG. 3A is a flow diagram of an example embodiment of a routine for a logging system of a media delivery system. FIG. 3B is a flow diagram of an example embodiment of a routine for correlating environmental data collected during rendering of media content to the rendered media content.

FIG. 4 is a block diagram of an example embodiment of a media delivery system.

### DETAILED DESCRIPTION OF EMBODIMENTS OF THE INVENTION

Techniques are described below for consolidating and correlating information about media content that is rendered at a specific time by a media delivery system manager coupled to a display with information about the number of impressions the content made on people within some detectable proximity of the display. Although described in terms of a media system manager and display, it should be understood that such media rendering and display devices, as well as other related components, are only exemplary. Other types of media, such as still pictures or audio, may also be rendered by embodiments of the invention by an appropriate display or playback device and information about the number and type of impressions of such content likewise collected, consolidated and correlated. In particular, although embodiments of the invention are described in terms of a media system manager, it will be understood that any computing device or devices capable of performing functions of the media system manager will suffice. Likewise, although the media delivery system and rendering of media content has been described in terms of advertising and advertising media, embodiments of the invention are not so limited. Embodiments of the invention may, therefore, render media that is not specifically advertising related.

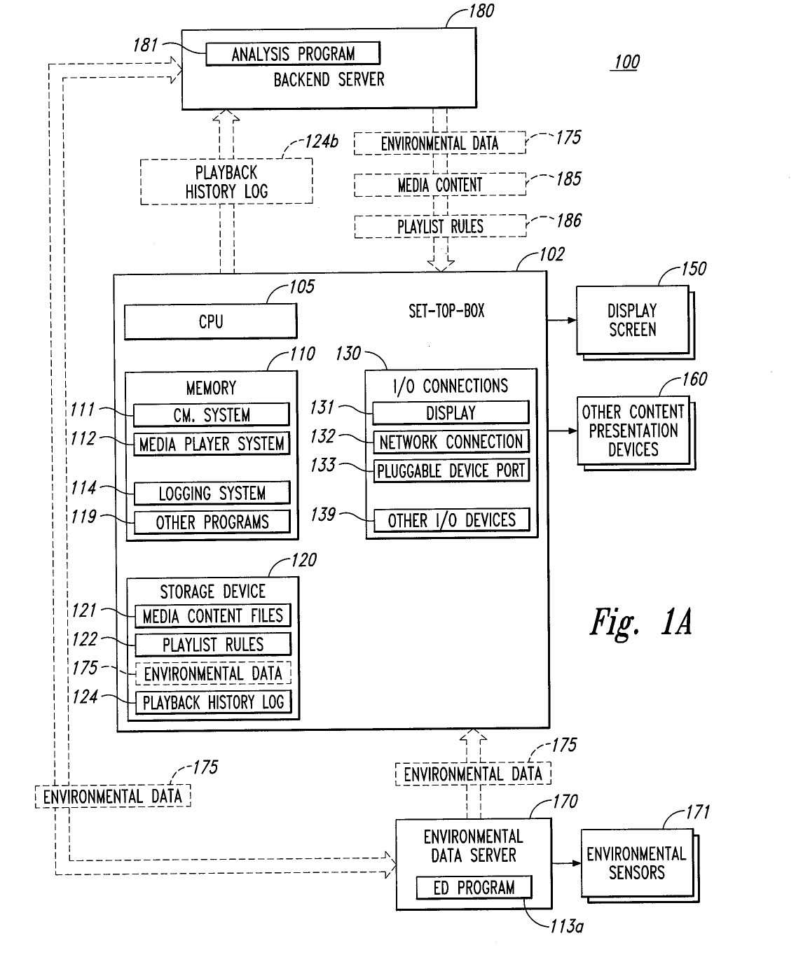

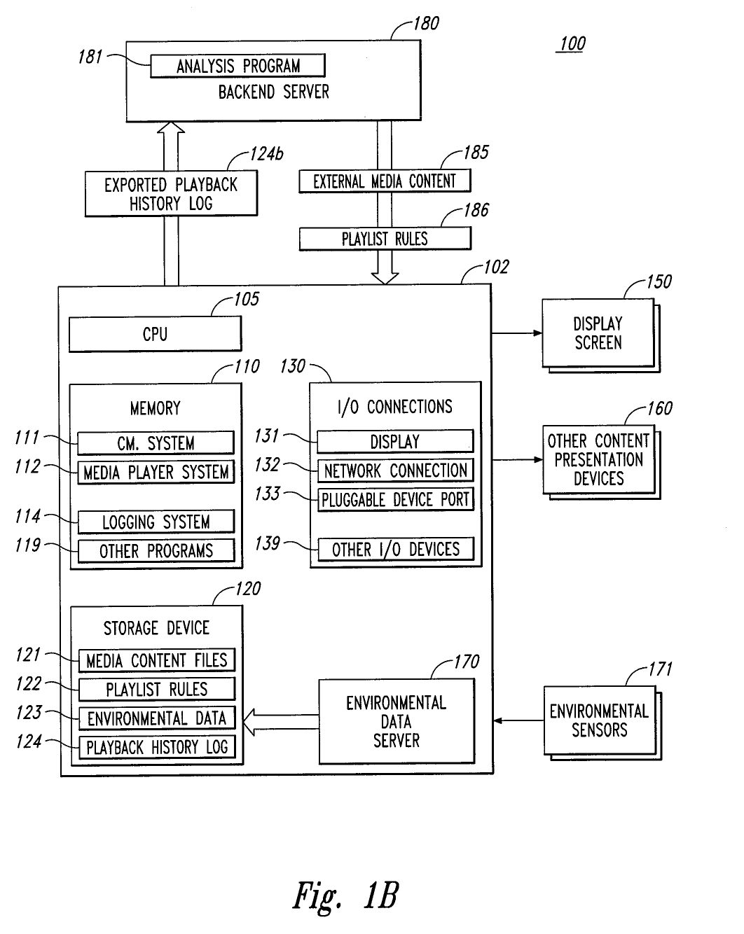

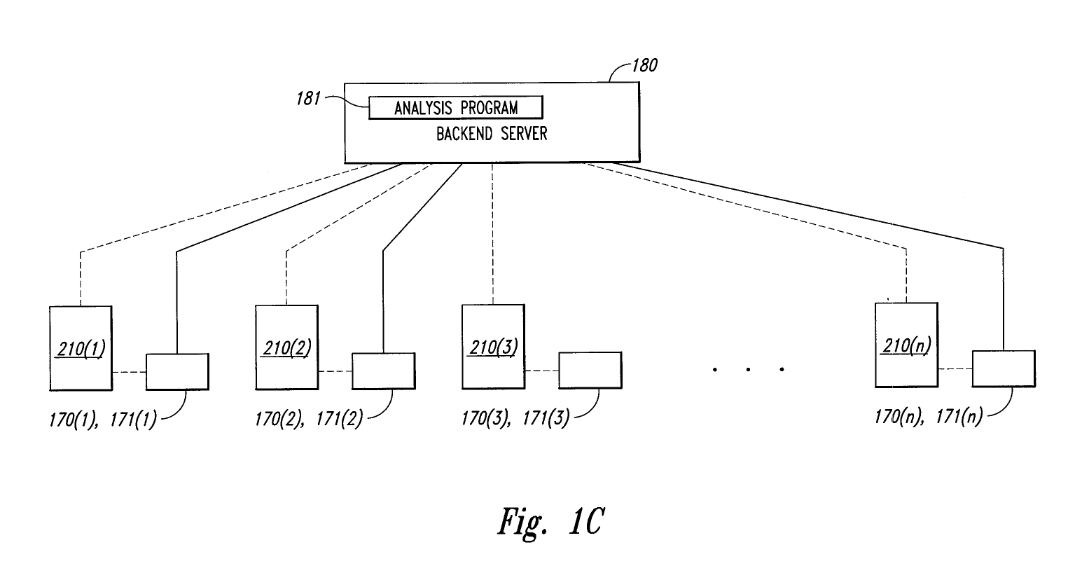

FIG. 1A depicts a media delivery system 100 according to one embodiment of the invention. The system 100 includes a media delivery system manager 102, a display 150, environmental sensors 171, an environmental data server 170 and a backend server 180. The media system manager 102 includes, among other things, a content management system 111, a media player system 112 and a logging system 114. Although discussed in terms of such components and programs, alternative embodiments of the invention are possible and it will be understood that the embodiments discussed below are for illustrative purposes only. In an alternative embodiment, the media system manager 102 may, for example, include only the content management system 111 and the logging system 114 whereas the media player system 112 is physically separate from the media system manager 102. Indeed, any of the functions of the content management system 111, the media player 112 and the logging system 114 may be performed by devices or systems that are physically separate.

The media player system 112, along with the display 150, or other content presentation devices 160, are used to render instances of media content that embody and convey the message intended for the audience. As will be discussed more fully below, media content 121 stored in storage device 120 is selected by the content management system 111 for playback and is processed and rendered on the display 150, or other content presentations devices 160, by the media player system 112. Examples of storage devices 120 include hard drives, flash memory, remote server, network attachable storage and other types of non-volatile storage and memory devices. Typically, the media content 121 is rendered as digital or analog signals which are routed to input/output (I/O) connections 130 on the media system manager 102. For example, in the case of video media, video signals are routed to the display I/O connection 130. Other types of media, such as audio or pictures, may be routed to other devices through their respective connectors 139. The I/O connections 130 further include a network I/O connection 132 for routing signals between the media system manager 102 and a network. The network I/O connection 132 might be comprised of, for example, a modem connection or an 802.11x WiFi connection. A pluggable device port I/O connection 133 can be used to connect the media system manager 102 to a pluggable device, as will be described in more detail below.

The output signals are then electronically transferred from these I/O connectors 130 to an appropriate device, for example, from the display I/O connection to the display 150 or from the I/O connectors 139 to some media content presentation device 160. In at least some embodiments, the output and input connectors follow A/V industry standard formats (e.g., Component, Composite, VGA, DVI, and HDMI). Such embodiments of the media system manager can process and render, for example, at least one of the following digital media formats using an associated CODEC: MP3, MPEG2, MPEG4, AVI and Windows Media files such as WMA (for audio) and WMV (for video). It will be understood that these digital media formats are only for illustrative purposes and other types of media might be rendered by the media player system 112.

The media delivery system 100 also includes an environmental data server 170 and environmental sensors 171. The sensors 171 are responsible for detecting environmental states, signals and conditions indicative of a human impression of the media content rendered by the media player system 112. The environmental data server 170 collects environmental data 175 resulting from the detected environmental states. In the embodiment of FIG. 1A, one or more sensors 171 are configured to count foot-traffic in the vicinity of the media delivery system manager 102 and are connected to the environmental data server 170. In one embodiment, the count of foot-traffic are interpreted to correspond to the count of impressions. As will be discussed more fully below, the count of impressions is stored and can be used with playlist rules or for post-processing. The sensors 171 may be connected through, for example, a wired connection, which includes an Ethernet, RS-232 serial, USB or modem connection, or they may connect wirelessly through, for example, an 802.11x Wi-Fi network, or a Bluetooth or Infra-Red connection. An environmental data program 113a is executed on the data server 170 and processes the signals received by the environmental data server 170 from the sensors 171. The environmental data program 113a can use various parameterized algorithms to determine whether the sensors 171 have detected a valid impression.

In at least some embodiments, in addition to being used for counting the number of impressions, the environmental sensors 171 are capable of capturing “dwell time” of a person in an area in the vicinity of the media delivery system manager 102. Dwell time is a measure of how long the person or persons remained in proximity of the sensors 171 or media delivery system manager 102. That is, in these embodiments the sensors 171 are capable of determining when a person is in proximity to the media delivery system manager 102, and additionally, determining how long they stay in proximity. Some examples of sensor types include, but are not limited to, thermal imaging camera sensors, infrared sensors, pressure sensors, video imaging camera sensors, sonar sensors, laser sensors, audio sensors, motion sensors and RFID tag sensors. In some embodiments, the environmental sensors 171 are integrated into or attached to the display device 150, and in other embodiments, the sensors 171 are integrated into or attached to the media system manager 102 itself. In other embodiments, the environmental sensors 171 may be installed anywhere within a suitable vicinity of the display device 150. For example, on the wall, ceiling or floor, within windows or doors, or self-contained and free standing.

The Environmental data 175, which includes the number of valid impressions, is transmitted to the media system manager 102 for further processing and, as will be discussed in more detail below, for use by content management system 111. The number of valid impressions and other environmental data are transmitted to the media system manager 102 via an I/O connection 130 such as, for example, the network connection 132 or through the pluggable device port 133.

The environmental data 175 is processed by the logging system 114 executing on the media system manager 102. The data is stored in the storage 120 temporarily or permanently on the media system manager as environmental data 123. In one embodiment, the media player system 112 communicates with the logging system 114 via an inter-process-communication mechanism, either in a event-driven or polling fashion, to provide playback information, such as playback state and metadata, of the media content the media player system 112 is rendering. The logger program 114 aggregates and correlates the media playback information, duration of the media content, and a timestamp of when the media content was rendered together with the environmental data 123. The resulting output of the logging system 114 is a playback history log file 124.

As was discussed above, the environmental data server 170 may process the signals received from the sensors to determine whether the sensors 171 have detected a valid impression. In an embodiment, such processing is done in real-time whereby the number of impressions is determined by the environmental data server 170 as sensor data is received from the sensors 171. In another embodiment, the sensor data and signals may be queued by the environmental data server 170 for processing at a later time. For example, after normal business hours when sensor data is not being gathered by the environmental data server (because, e.g., the store is closed), the system is relatively idle and the CPU cycles of the system may be advantageously utilized during this time. Likewise, the processing needs of the system are reduced during peak periods of environmental data gathering because the system is tasked only with storing the signals and data from the sensors 171 and not with also processing such data at that time. Such an embodiment may permit the media delivery system to use less expensive hardware since the peak processing load on the system is lower.

In some embodiments, the environmental data server 170 may be configured to detect and log environmental data that is erroneous or fraudulent. It is generally desirable that embodiments of a media delivery system gather accurate information regarding the number of impressions. In certain environments, the system may log impressions that should not be counted. For example, when placing an embodiment of the media delivery system manager in a store, impressions made by store employees generally should not be counted. In an embodiment, the environmental data server 170 may be configured to identify particular individuals based on various environmental data and to exclude impression counts for such persons. In an embodiment, the environmental data server 170 may work in conjunction with one or more sensors 171 that detect the presence of persons who should not be counted when gather impression data. Such sensors could, for example, detect an RFID tag embedded in the employee's name badge. Other sensors are possible as is discussed below and detection of an RFID tag is exemplary only.

In other cases, persons may wish to intentionally deceive an embodiment of the environmental data server into collecting impressions that are not, in fact, valid. For example, a competitor of an advertiser may wish to trick the system into logging so many impressions or otherwise flooding the system with false data, that the advertiser is incapable of gathering any useful information about the effectiveness of their advertising. In one embodiment, the environmental data server 170 may be configured to algorithmically detect possible fraudulent impressions. For example, the environmental data server 170 may use a smoothing or filtering algorithm to remove large spikes in traffic when they may indicate attempts are being made to deceive the system.

In other embodiments, the environmental data server collects and logs data that can be accessed by a user and auditors. This may be desirable for an external auditor to confirm that the data sensed and collected by the system is accurate. An example of gathering audit data includes capturing and storing a photograph every 30 seconds that can be compared with foot-traffic counts obtained using a video camera environmental sensor 171 to confirm that the video sensing technology accurately counts foot-traffic. Other techniques of gathering audit data for verification of data collected by the environmental data server can be used as well.

Although an environmental data server and environmental sensor will typically detect and log valid impressions of delivered media, embodiments of the environmental data server may also use non-automated counting mechanisms. In one such embodiment, the sensors 171 could include a video camera of the vicinity of the media delivery system manager and the video footage of that camera could be routed to actual humans who watch the video and manually count the number of impressions on the system.

As previously discussed, instances of media rendered by the media delivery system manager may include a variety of different types of media such as video, audio or still pictures. In one embodiment, such media is managed by the content management system 111 which is part of the media system manager 102. The content management system 111 enables a user to define playlist rules 122 that govern what media content 121 is to be loaded onto the storage 120 of the media system manager 102 for playback as well as for defining playlist rules that govern when or how often instances of media content are to be rendered on the display device 150 or other content presentation devices 160.

In some embodiments, the playlist rules that govern the playback of media content, along with the media content files, are transferred onto the media system manager 102 from an external location such as another networked computing device, such as the backend server 180. In other embodiments, where network connectivity is not available, such rules and media content may be transferred from an external data store onto a removable memory storage device (not shown) (e.g., a Universal Serial Bus (USB) flash memory drive), and then transferred from the removable memory storage device onto the media system manager 102 by connecting the removable memory storage device to a compatible I/O connection 130 on the media system manager 102, for example, a USB port. Although discussed in terms of a USB flash drive, other modes of transferring playlist rules and media content are possible. For example, other forms of portable, non-volatile storage such as DVDs, CDs, tape or floppy disk or Memory Cards such as Compact Flash, Secure Digital Card, MultiMedia Card, SmartMedia, Memory Stick, Memory Stick PRO, xD-Picture Card or a Micro Drive might be used instead. In alternative embodiments where Internet connectivity is not possible, the environmental data server communicates with the backend server 180 via a modem or other data connection.

Turning to the playlist rules, many different rules can be specified, with the number and type of rules related to the capabilities of the media system manager 102 and environmental sensors 171. An example of a simple playlist rule is one that is time based. For example, the content management system 111 can be instructed via a playlist rule to play a certain media selection according to the current time of day, day of the week, or a combination of the two. The rules can further specify a sequential, random or weighted randomization of media selections during a given time period. Different rules can be applied to different times of the day and on different days of the week. For example, supposing an embodiment of the invention were placed on a commuter train for playing advertisements or other media to commuters. In such a situation, the audience would be different during the rush hour commute than it would be, for example, at noon. Likewise, the audience on such a train would be different on the weekend than it would be during an ordinary mid-week work day. Playlist rules allow embodiments of the invention to be sensitive to these differences and enable an advertiser, for example, to tailor the selection and playback of media accordingly.

Another example of a playlist rule is one which specifies that the same media should not be repeated within a given period of time. In the commuter train example above, it is likely that almost the same audience would be on board the train from, for example, the suburbs into the city. Once the train has emptied at its destination, the playlist rules could permit the media selections to repeat because presumably, a new audience would be present to see the media content.

Playlist rules may also specify quotas for specific media with promotion or demotion of playback priority based on the number of impressions each media has received. For example, suppose a particular advertisement, ‘ad A’, is targeted to receive 100 impressions in a month. Suppose that ‘ad B’ is targeted to receive only 50 impressions per month. Further suppose that ‘ad B’ has already received 40 impressions while ‘ad A’ has received only 30. The content management system 111 may, in such a situation, boost the priority of ‘ad A’ so that it plays more frequently and likewise decrease the play priority of ‘ad B’ so it plays less frequently. In this way, the media delivery system can increase the likelihood that each advertisement will receive its targeted number of impressions. The play priority for any given piece of media may also be specified based on a premium service where advertisers, for example, pay a premium for more impressions or for playback priority.

In other embodiments, media can receive a higher playback priority because of its particular perishability. That is, certain media content is particularly time sensitive and in recognition of this, such media will receive a higher playback priority to hopefully increase the number of impressions. Examples of such media could involve sporting events (e.g., the Super Bowl), the season finale of a popular television show or media content related to an election.

More complex playlist rules can be used by the content management system 111 in conjunction with environmental data 175 provided by the environmental data server 170 and environmental sensors 171. In one embodiment, the environmental sensors 171 act as traffic counters that simply count the number of persons passing in proximity to the media delivery system manager. The traffic count is provided as feedback to the environmental data server as was previously discussed. According to a particular rule, the content management system 111 may then prioritize the playback of specific media items or groups of media for playback during times of high traffic. It can also be specified in the playlist rules that the same media should not be played back-to-back. The playlist rules can also be used to have the content management system 111 prioritize specific media items or a group of media items to playback when the system senses a high traffic-count. A high-traffic count might be characterized in different ways. For example, the content management system 111 might consider passing a certain traffic-count threshold as “high-traffic.” Alternatively, the content management system 111 could characterize a large change in traffic within a certain period of time as high traffic and ignore the raw number of traffic counts altogether.

Although traffic counting sensors are perhaps the most common type of environmental sensors 171, more sophisticated sensors are capable of sensing and measuring more complex data for use with more complex playlist rules and data gathering. For example, as previously discussed, some sensors are capable of measuring the dwell time of a person or persons within a proximity of the media delivery system manager. Such capability is useful for helping determine the efficacy of any given advertisement. For example, it is advantageous to know that while ‘ad A’ was watched by 10 persons, only 2 of them stay for the entire 30 second duration of the advertisement. This data is valuable if you also know that ‘ad B’ was also watched by 10 persons and 8 of them stayed for the entire 30 second duration of the advertisement. The simplest sensors would detect only proximity and determine how long a person or persons are in proximity to the media delivery system manager.

Another type of sensor could read the information stored in an RFID tag. Such a tag might be placed in products sold in a store. In one embodiment, the sensors for an environmental data server could determine what the quantity and type of products a person has in their shopping cart as they approach the system in a retail store. Such data could then be used to select media for playback that is tailored for that particular person and their buying habits. Alternatively, RFID tags could be placed in the name tags of persons attending a large convention. The RFID tag could store information about that particular persons area of expertise. The RFID tag could then be read as the person moves about the convention and media content that would be of interest to such a person could be adaptively rendered by a media delivery system as they pass by.

In yet another embodiment, environmental sensors could possibly detect the height and weight of a person in proximity to the media delivery system manager. Such information might be particularly useful especially when coupled with other information. Perhaps, for example, the playlist rules can be used to have the sensors 171 interpret a shorter, lighter person in front of the system during after-school hours between 3 and 5 P.M. to be children. In such instances, the playlist rules can further control the content management system to render media content intended for children.

Embodiments of the invention might also include one or more environmental sensors capable of tracking the attention of persons in proximity to the media delivery system manager. There are many possible configurations of attention tracking sensors. Some attention tracking sensors, for example, can track the attention of a subject through the measurement or detection of aspects of the subject's face. One such attention tracking sensor might, for example, use a camera and suitable illumination to capture images of an area in proximity with the media delivery system manager. Suitable processing of the images could be used to determine the locations of people within the image and in particular, where those people are actually looking. Such processing could, for example, detect whether a person is looking at the screen based on, for example, the angle of their facial features within the captured images. As is known in the art, there are complex algorithms such as the mean shift algorithm that allow for face recognition and face tracking and such algorithms may be advantageously employed in an attention tracking sensor.

Alternatively, methods exist for attention tracking based on tracking only on the eyes. A suitable eye tracking algorithm may process the captured images in order to determine whether the subject's eyes are pointed at the media delivery system. Attention tracking using only the eyes may be advantageous in certain lighting situations or where the particular illumination results in accentuation of the eyes within the captured images. Attention tracking using both the eyes and other aspects of the face or head may be advantageous since although a person's face may be generally facing the media delivery system, they may not be looking directly at the system. Instead, for example, they may be looking at something behind or to the side of the system. Use of eye tracking may thus permit attention tracking sensors to be more accurate. An attention tracking sensor incorporated into the embodiment depicted in FIG. 1A would allow the environmental data server to determine whether each individual in the defined field is looking at the display 150 from moment to moment.

Attention tracking sensors would permit embodiments of the environmental data server to gather information on how long each individual looks at the screen. Gathering such information on a second-by-second basis permits gauging the effectiveness of a particular instance of media content, or different time segments within that instance, in getting and maintaining the attention of people. Likewise, through the use of an appropriate playlist rule, one embodiment of the media delivery system could dynamically alter rendering of media in response to changing interest in the media being rendered. For example, suppose a person is watching the display 150 of the embodiment depicted in FIG. 1A. An attention tracking environmental sensor connected to such an embodiment could detect that the person is no longer paying attention or has averted their gaze in some manner, and that information could cause the system to start rendering a different instance of media. Alternatively, other embodiments of the system might change the volume of sound, change the brightness of the display, or other parameters of media playback in an attempt to regain the person's attention.

An attention tracking environmental sensor could also permit more accurate determination of a person's size, shape, height or the speed with which they move. Such information could be used by embodiments of the invention to generate probabilistic demographic information. Such information is useful and valuable in and of itself. Such information might also, however, be used by a playlist rule within an embodiment of the invention to custom tailor a media selection suitable for the person mostly likely to be watching the display at that moment.

In an embodiment, attention tracking environmental sensors may be used with face recognition algorithms to identify one or more persons in proximity with the media delivery system manager. Identification of the person or persons might employ many different face recognition algorithms as is known in the art. In an embodiment, the system compares the face or facial feature data detected by the attention tracking environmental sensors to face or facial feature data stored in, for example a database of faces and features. The database may be pre-populated with face data of particular persons of interest. Alternatively, the system may cross-reference 3^{rd} party databases that contain face data. For example, the system could reference face data from the FBI's Ten Most Wanted list or face data of missing children from the Center for Missing Children. In this embodiment, the environmental data server may then also notify and assist local agencies when a person of interest is detected in the vicinity of the system. In addition to notification and assistance, the environmental data server may also be configured to raise a local alert by, for example, displaying the image of the person of interest on the screen (e.g., a missing child poster) and sounding an alarm.

Many types of environmental sensors must be properly, and perhaps continually, calibrated to provide accurate measurement. Embodiments of the invention may provide mechanisms for manual, automatic and/or continual calibration of the environmental sensors. For example, some embodiments of a environmental data server may initiate playback of a calibration tone periodically to calibrate an audio sensor within the system. Such a system with a video camera may, for example, be calibrated by having a calibration image within the field of view of the camera and initiating calibration procedures on the camera.

With further reference to FIG. 1A, although the media system manager 102 is capable of functioning more or less autonomously using playlist rules and environmental data, the media system manager 102 may also periodically synchronize with the backend server 180. In some embodiments, the backend server 180 may optionally receive the playback history log file 124 and may optionally upload new media content 185 and playlist rules 186 to the media system manager 102 (shown in FIG. 1A by the dashed lines). In some embodiments, the media system manager may continually communicate with the backend server 180 allowing the playback history to be communicated to the backend server 180 in real-time. The playback history log file 124 may be reformatted and exported as some digitally transmittable format prior to being transmitted to the backend server 180. In some embodiments, the transmission makes use of HTTP over TCP/IP protocols between media system manager 102 and the backend server 180, which could be connected via an Ethernet network. The connection could also be wireless using an 802.11x Wi-Fi network, Bluetooth connectivity, Cellular connectivity, radio frequency, or some variation thereof.

The transmitted playback history log file 124 is collected, stored, and analyzed on the backend server 180 and available for various reporting functionality as needed by the user of the system. The backend server 180 is able to support the simultaneous collection of playback history log file 124 from multiple media system managers 102. The playback history log files 124 are aggregated and processed by an analysis program 181 that executes on the backend server 180. The analysis program 181 generates reports, and can further allow users to interactively query and view the imported playback history log file 124 and aggregated information.

In some embodiments, the environmental data 175 is provided to the backend server 180 from the environmental server 170 rather than it being provided from the media delivery system manager 102 as part of the playback history log 124b. Such embodiments may be of benefit in some implementations of the media delivery system. For example, the media delivery system manager that renders the media content may process the environmental data. In another example, a trusted intermediary may collect the environmental data for auditing. In another example, the environmental data from many environmental data servers may need to be aggregated before the information is acted upon by media delivery system managers. The backend server 180 may optionally in communication with the media delivery system manager 102 to receive playback information 124b as well as provide external media content 185 and content management rules 186 to the media delivery system manager 102. The backend server 180 may also provide environmental data 175 to the media delivery system manager 102, which optionally stores the environmental data 175 in storage device 120.

In operation, the media delivery system manager 102 renders media, such as advertisements, according to the playlist rules 122. Concurrently with the rendering of the media, the environmental data server 170 collects environmental data 175 using the environmental sensors 171. As previously discussed, the environmental data 175 can include different types of information, including, for example, the count of foot-traffic, dwell time, physical characteristics of people, and attention count of people in proximity of the media delivery system manager 102, in order to obtain information indicative of human impressions of the media content rendering during playback.

The environmental data 175 is provided to the backend server 180 for correlation to the media content that is rendered while the environmental data 175 is collected. In this manner, the environmental data server 170 and environmental sensors 171 can be used in conjunction with the media delivery system manager 102 to provide playback history, but without the need for the environmental data server 170 (or the environmental sensors 171) to be in communication with the media delivery system manager 102. In alternative embodiments, however, the environmental data server 170 can be optionally in communication with the media delivery system manager 102 to provide it with environmental data 175 in addition to providing the environmental data 175 to the backend server 180.

In some embodiments, the playback information 124b provided by the media delivery system manager 102 to the backend server does not include environmental data that is collected during the rendering of media by the media delivery system manager 102, for example, where the environmental data 175 is provided by the environmental data server 170 to the backend server 180. In some embodiments, however, the playback information 124b does include collected environmental data 175, in particular, in the embodiments where the environmental data server 170 is optionally coupled to the media delivery system manager 102.

As previously discussed, the environmental data 175 provided to the backend server 180 by the environmental data server 170 is correlated to playback information for the rendered media content by the analysis program 181 in order to generate information indicative of the count of mental impressions occurring during playback of respective media content. In some embodiments, the playback history log 124b provided by the media delivery system manager 102 to the backend server includes time information for when the media content is rendered. The environmental data 175 also includes time information for the environmental data collected. By correlating the time information for the media content rendered and the environmental data collected, the number of mental impressions made by people during rendering of particular media content can be calculated.

In some embodiments, time information for the rendering of media can be obtained by the backend server 180 from the playlist rules 122/186. As previously discussed, the playlist rules 122/186 govern rendering of the media content, including the time at which the media content is rendered. Time information from the rendering of media content may be extracted form the playlist rules. The playlist rules 122 can be provided to the backend server 180 as part of, or separately, from the playback history log 124b. The playlist rules 122 may already be with the backend server 180. For example, the playlist rules may be uploaded to the backend server 180 from a source other than the media delivery system manager 102. Another example is where playlist rules 186 are provided to the media delivery system manager 102 from the backend server 180, the backend server 180 can maintain a copy of the playlist rules 186 in order to reference the time information for when the media content is rendered.

As part of correlating the collected environmental data 175 to playback information for the rendered media content, the timing of the environmental data 175 and the playback information should be synchronized so that the environmental data 175 is accurately correlated to the correct corresponding rendered media content. In some embodiments, the environmental data server 170 and the media delivery system manager 102 operate according to a common clock. As a result, timing information of the environmental data 175 and the rendering of media content will be the same and already synchronized. The common clock may be a system clock shared by the environmental data server 170 and the media delivery system manager 102. In some embodiments of the invention, the common clock is provided by a time server with which both the environmental data server 170 and the media delivery system manager 102 are in communication. In some embodiments, the common clock is provided by a publicly available time server with which both the environmental data server 170 and the media delivery system manager 102 or in communication.

In other embodiments of the invention, the environmental data 175 and the playback information are synchronized by detecting transitions that occur when the rendering of first media content ends and second media content begins. These transitions are marked while environmental data 175 is collected by the environmental data server 170. In this manner, given a common starting point for the collection of environmental data 175 (and the detection of transitions) and the rendering of media content, the environmental data 175 between transitions can be matched with particular media by the backend server 180. For example, assuming that rendering of a first media content and collection of environmental data 175 are started at the same time, the environmental data 175 up until the first detected transition can be assumed to have been collected during the rendering of the first media content. The environmental data 175 following the first detected transition until the next detected transition can be assumed to have been collected during the rendering of a second media content. The matching of the environmental data 175 between transitions with the subsequently rendered media continues to synchronize the rest of the environmental data with the rendered media content.

Detection of transitions in the rendering of media can be accomplished using different techniques. For example, in some embodiments, the media delivery system manager 102 provides the media content being rendered, such as that provided to the display screen 150, to the environmental data server 170. The environmental data server 170 can process the media content to detect the end of one media content and the beginning of the next media content to identify the transitions. The media content may be provided to the environmental data server 170 in parallel to it being provided to the display screen 150. The media content may be provided to the environmental data server 170, which in turn provides the media content to onto the display screen 150. Other techniques may be used as well without departing from the scope of the present invention.

Another implementation of detecting transitions in the rendered media content is to include a sensor coupled to the environmental data server 170 that monitors and detects transitions in the rendering of the media content. For example, a visual sensor coupled to the environmental data server 175 can monitor rendering of media content on the display screen 150 and detect when the rendering of one media content ends and the rendering of another media content begins. The detection of a transition is provided to the environmental data server 170 to be included with the environmental data 175 provided to the backend server 180.

FIG. 1B depicts an embodiment of the media delivery system wherein the environmental data server 170 is integrated into the media system manager 102. Such an embodiment obviates the need for network connections between the environmental data server 170 and the media system manager 102 as well as the need for separate server hardware for the environmental data server. In some embodiments, the environmental sensors 171 are likewise directly connected to the media system manager 102. The functionality of these embodiments is otherwise identical to the embodiments discussed above.

Embodiments of the invention such as, for example, those pictured in FIGS. 1A and 1B may also incorporate mechanisms to detect and log error conditions that may arise within the system. One or more of the environmental sensors 171 may, for example, develop severe mechanical or electrical problems that require the attention of a repair technician. Alternatively, certain error conditions may arise that may be quickly remedied. For example, a video camera being used as an environmental sensor may detect insufficient light for proper recording. This could be due to low ambient lighting conditions or, for example, an obstruction place in or on the camera itself. Suitably programmed embodiments of the invention may log such errors and optionally transmit the log via the network, or other means, to a reporting station. Another embodiment may raise a local alert allowing personnel local to the system to effect a repair in some simple situations such as, for example, removal of the obstruction in front of the video camera environmental sensor as described above.

Embodiments of the invention may also incorporate a remote administration capability. Some embodiments of a media delivery system will typically be located at a remote location such as a store or other public venue as discussed above. Costs associated with a technician making a service call to these locations may be considerable. To reduce or eliminate these costs, embodiments of the invention may be remotely monitored and administered. Such administration capability may include the ability to logon to the system through a network or other interface, examine and adjust system settings, monitor the environmental sensors and/or update playlist rules and media.

FIG. 1C illustrates a media delivery system 200 according to an embodiment of the invention. The media content delivery system 200 includes a backend server 180 coupled in communication with environmental data servers and environmental sensors 170,171(1)-170,171(n). The communication medium between the backend server 180 and the environmental data servers and environmental sensors 170,171(1)-170,171(n) includes both wired and wireless mediums. As previously discussed, the backend server 180 includes the analysis program 181. The media content delivery system 200 further includes media delivery system managers 210(1)-210(n), which can be optionally (as indicated in FIG. 1C as dashed lines) coupled to be in communication with the backend server 180. The communication medium between the backend server 180 and the environmental data servers and environmental sensors 17

0,171(1)-170,171(n) and the communication medium between the backend server 180 and the media delivery system managers 210(1)-210(n) include both wired and wireless mediums. The environmental data server and environmental sensors 170, 171 may also be coupled to be in communication with the respective media delivery system managers 210 as well. Media delivery system managers according to embodiments of the invention, such as media delivery system manager 102 described with reference to FIGS. 1A and 1B can be substituted for the media delivery system managers 210.

The backend server 180 collects environmental data 175 from the environmental data servers 170(1)-170(n). The backend server 180 may collect playback history log files from the respective media delivery system managers 210(1)-210(n) as well. The backend server 180 associates the environmental data from each of the environmental data servers 170(1)-170(n) to a respective media delivery system manager 210(1)-210(n). In some embodiments, identification information for an environmental data server 170 is assigned to match identification information for the media content delivery system manager 210 for which environmental data is being collected. In this manner, the backend server 180 can match the environmental data to the correct respective media delivery system manager 210. In some embodiments, an environmental data server 170 is associated to a respective media delivery system manager 210 by setting location information for the environmental data server 170 to the same location information of the media delivery system manager 210 for which environmental data is being collected. Examples of location information include street address, a textual location description, GPS coordinates, and the like. Other forms of location information can be used without departing from the scope of the invention. The present invention includes embodiments that have the location information of an environmental server 170 set by manual programming as well as automated programming, such as by having a respective media delivery system manager 210 provide its location information to an associated environmental data server 170. In some embodiments, the location information of a respective media delivery system manager 210 is provided using wireless communication with the environmental data server 170, for example, using Bluetooth, Infrared, Wi-Fi, and other wireless communication protocols.

In some embodiments of the invention, the environmental data servers and environmental sensors 170,171(1)-170,171(n) and the media delivery system managers 210 belong to different networks that are coupled to be in communication with the backend server 180. In this manner, the backend server 180 can aggregate environmental data from across different networks.

By aggregating the environmental data, the backend server 180 can monitor the environmental data and rendering of media content by the media delivery system managers 210. For example, the environmental data can be used to provide a count of impressions for particular media content, such as a particular advertisement that is rendered by several different media delivery system managers 210. Where the particular advertisement is to be rendered until a certain number of impressions are detected, the backend server 180 can track a total impression count across the different networks for the particular advertisement in order to determine when the certain number of impressions is reached. It may be that the occurrence of impressions for the particular advertisement at some locations of the media delivery system managers 210 is higher than for other locations. By having the backend server 180 track the total impressions for all of the media delivery system managers 210 rendering the particular advertisement, a more accurate understanding of when the certain number of impressions is reached as well as which locations the particular advertisement receives greater notice by viewers can be obtained.

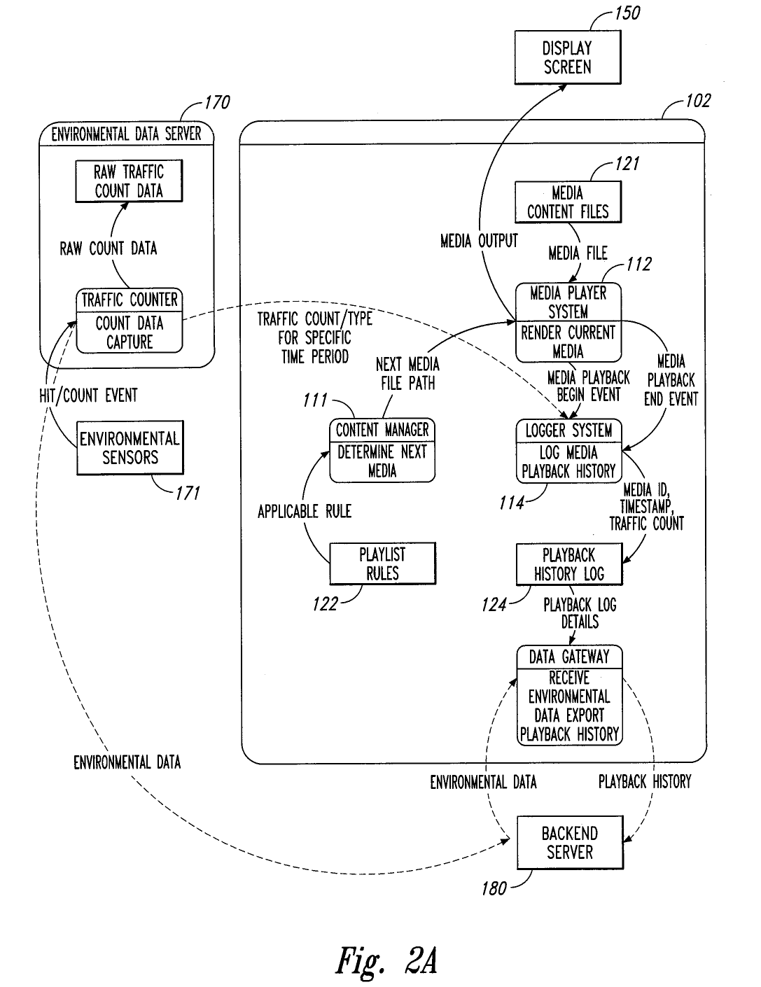

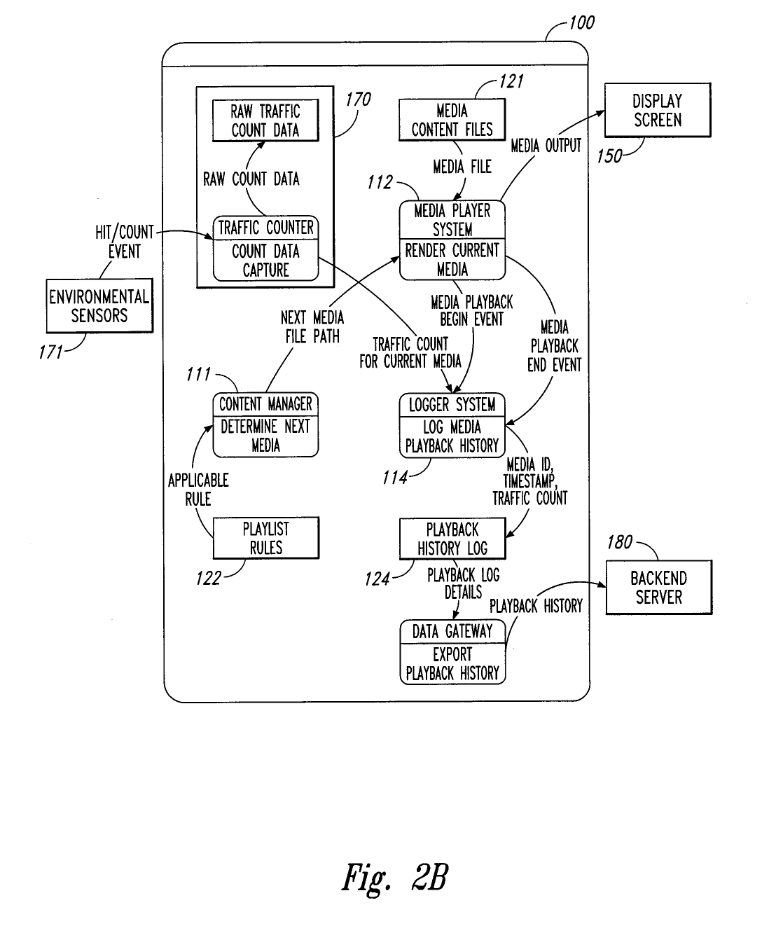

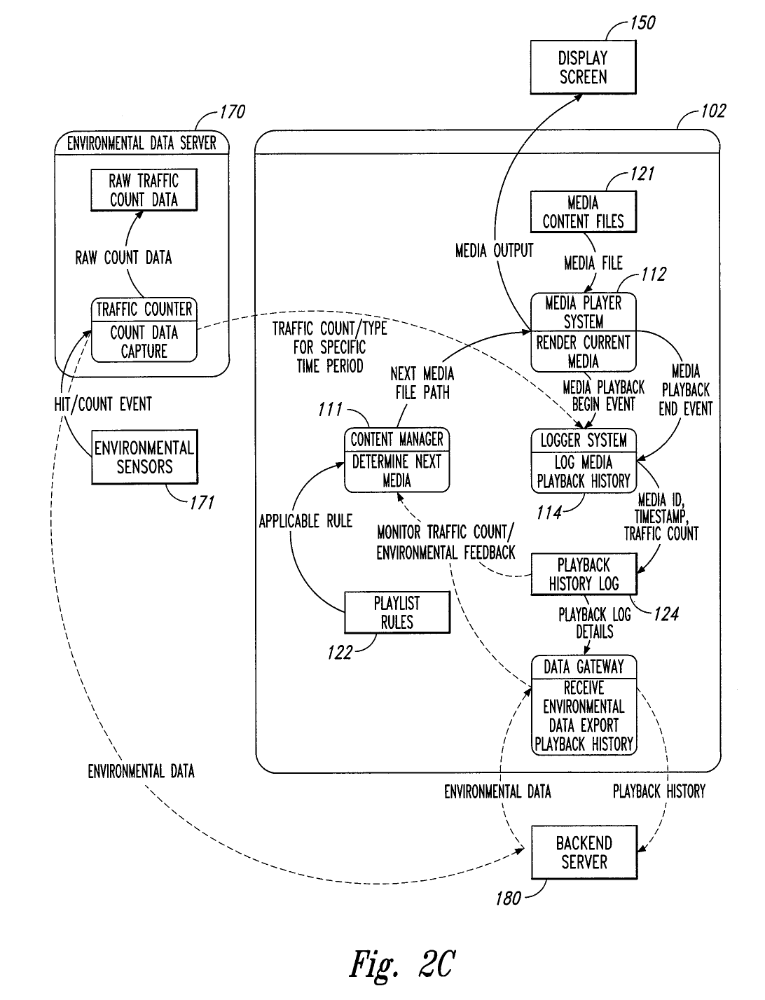

FIG. 2A is a data flow diagram that describes the flow of data within the embodiments of the media delivery system described with reference to FIG. 1A above. Operation of this embodiment of the media delivery system typically begins with the content management system 111 determining the next media to render in accordance with the playlist rules 122. The content management system 111 communicates the location of the next media to the media player system 112. The media player system 112 retrieves the appropriate media file from the media content files 121 and then typically renders the media on, for example, the display screen 150. When the media player system 112 begins to render the media, it generates a media playback begin event which is communicated to the logger program 114. When the media player system 112 stops rendering that particular media, it generates a media playback end event that is also communicated to the logger program 114.

While the media is being rendered, the environmental sensors 171 begin detecting impressions and generate count events which are communicated to the environmental data server 170. In some embodiments, the environmental data is exported to the backend server 180. In some embodiments, the traffic count and type of traffic is passed from the environmental data server 170 to the logger program 114. During the period of time between the media playback begin event and end event, the logger program 114 logs the media ID, the timestamp and the traffic count and other environmental data to the playback log file 124.

FIG. 2B is a data flow diagram that describes the flow of data within the embodiment of the system wherein the environmental data server 170 is integrated into the media system manager 102 and as depicted in FIG. 1B. The data flow shown in FIG. 2B is essentially the same as that of FIG. 2A except that the environmental sensors 171 communicate directly with media system manager 102 and its integrated environmental data server 170.

FIG. 2C is a data flow diagram of an example embodiment of a media delivery system where the collected environmental data is used as feedback to help determine the next media to play. During the time that the media player system 112 is rendering a media content file and the logger program 114 is likewise creating the playback history log 124, information about the traffic count and other environmental feedback is communicated back to the content management system 111. This feedback is used in conjunction with the playlist rules 122 to determine the next media content to render. The data flow depicted in this Figure is otherwise identical to that of FIG. 2A.

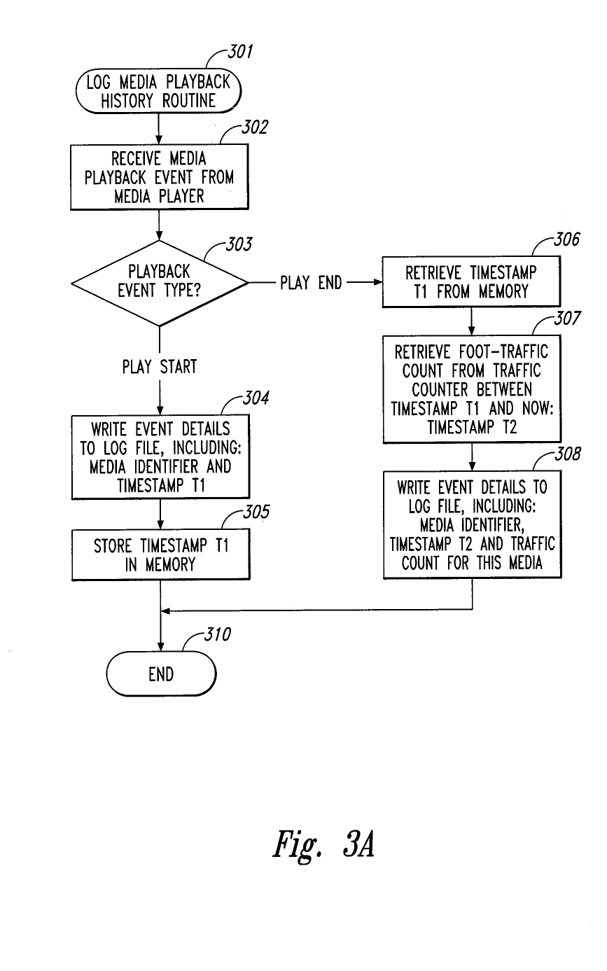

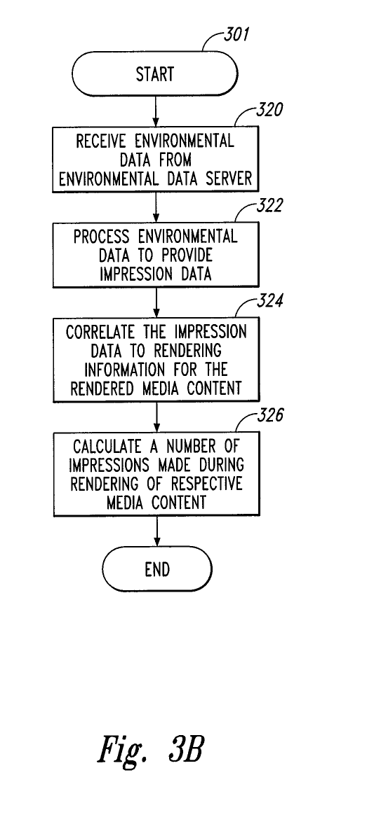

FIG. 3A shows a flow chart diagram for one implementation of the log media playback history routine 301 of the logging system 114. A media playback event is received from the media player system 112 at step 302. The logging system 114 checks the playback event type at step 303. If the playback event type is a “Play Start” event, the event details are written to the log file at step 304, including the media identifier and timestamp T1 information. The timestamp T1 is stored in memory at step 305 for use later when a “Play End” event is received. The routine ends 310. If the playback event type is a “Play End” event, the timestamp T1 that was stored in memory is retrieved at step 306. In embodiments where the environmental data is provided to the media delivery system manager as well as to the backend server 180, the environmental sensor count data for the time interval between timestamp T1 and the current timestamp T2 can optionally be retrieved from the environmental data 123 at step 307. The event details are written to a playback history log file 124 at step 308 including the media identifier, the timestamp T2, and environmental sensor count data (where provided to the media delivery system manager). Once the playback history log file 124 has been completed, it may be exported to the backend server 180 for further analysis.

FIG. 3B shows a flow chart diagram for an implementation of the backend server 180 according to some embodiments of the invention, in particular, for embodiments having the backend server 180 receiving environmental data 175 from the environmental data server 170, instead of or in addition to, receiving the environmental data from the media delivery system manager 102.

The backend server 180 receives environmental data 175 from the environmental data server 170 at step 320 which is collected during rendering of media content by the media delivery system manager 102. The environmental data 175 is then processed at step 322 by the backend server 180 to generate impression data indicative of the number of impressions detected during the rendering of media content. The impression data is correlated at step 324 to information for the media being rendered while the environmental data 175 was collected by the environmental data server 170. The backend server 180 uses the impression data at step 326 to calculate a number of impressions for respective media content, that is, provide a number of impressions for each of the media content rendered by the media delivery system manager 102.

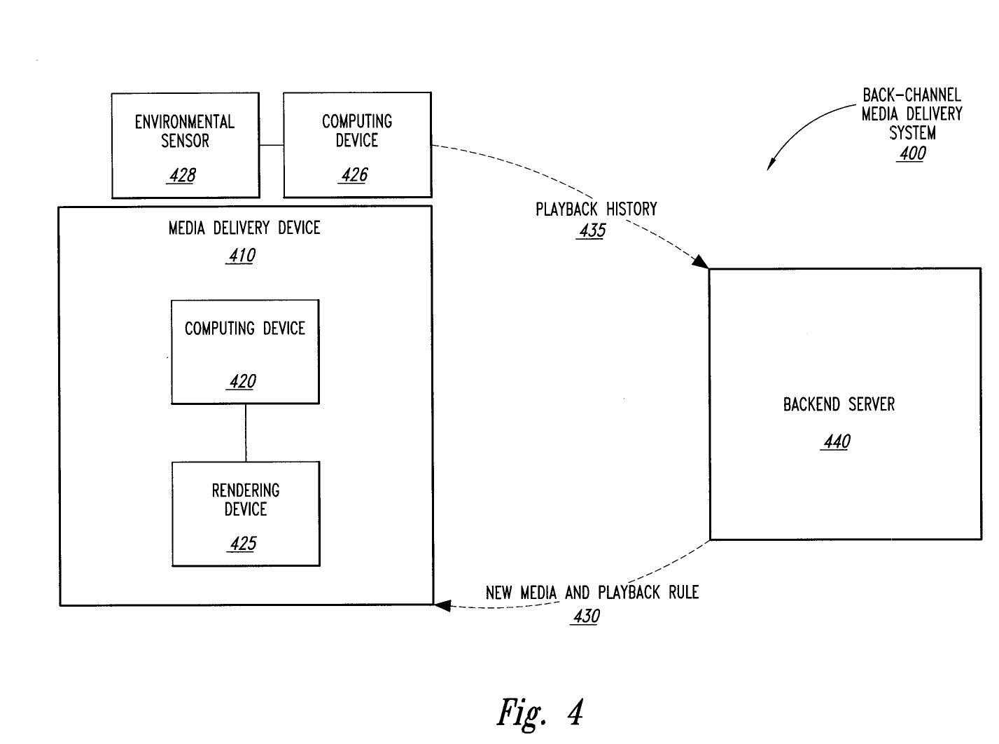

FIG. 4 depicts a high level block diagram media delivery system according to one embodiment of the invention. Although FIG. 4 illustrates a particular embodiment, it will be understood that alternative embodiments are possible as is evident from the embodiments and variations described above. The media delivery system 400 includes a media delivery device 410, environmental data server and environmental sensors 426, 428, and a backend server 440. The environmental data server 426 is shown in FIG. 4 as a computing device, which can be used to implement the environmental data server. The media delivery device 410 includes a computing device 420. The media device 410 includes a rendering device 425 coupled to the computing device 420. The computing device 420 selects media stored on the computing device 420 for rendering on the rendering device 425. Alternatively, the computing device 420 may select media stored elsewhere. The computing device 420 then renders the media on the rendering device 425. While rendering the media, the environmental data server 426 gathers environmental data from the environmental sensors 415 and provides the data to the backend server 440. The computing device 420 compiles playback history 435 and may transmit this history that is received by the backend server 440. As was discussed more fully above, the backend server 440 is used to process and analyze the data. From this data, new playback rules may be devised for use by the media delivery device 410 during future renderings of new media on the rendering device 425. New media and playback rules 430 are then transmitted to the media delivery device 410. It will be understood that receiving the environmental data and optional playback history 435 by the backend server 440 and sending the new media and playback rules 430 to the media delivery device 410 may be accomplished in numerous ways. For example, and as was discussed more fully above, the communication may take place via various types of wired or wireless connections or via non-volatile media.

From the foregoing it will be appreciated that, although specific embodiments of the invention have been described herein for purposes of illustration, it will be understood by one skilled in the art that various modifications may be made without deviating from the invention. Accordingly, the invention is not limited except as by the appended claims.

What is claimed is:

1. A media delivery system comprising:
a media rendering device configured to render an instance of media content;
at least one environmental sensor positioned proximate the media rendering device and configured to detect an environmental state in proximity to the media rendering device;
an environmental data server coupled to the at least one environmental sensor and configured to gather environmental data using the at least one environmental sensor during rendering of the media content; and
a backend server coupled to receive the environmental data and configured to correlate the environmental data to the media content rendered on the media rendering device to generate data indicative of a number of impressions for the rendered media content.

2. The media delivery system of claim 1 wherein the backend server is coupled to be in communication with the environmental data server and receive the environmental data therefrom.

3. The media delivery system of claim 2 wherein the backend server is further coupled to be in communication with the media rendering device and receive data regarding the rendering of the media content.

4. The media delivery system of claim 1 wherein the environmental data server is further coupled to the media rendering device and configured to provide environmental data to the same.

5. The media delivery system of claim 1, further comprising a plurality of environmental data servers coupled to a respective environmental sensor and further coupled to the backend server, the back end server configured to be in communication with the plurality of environmental data servers and configured to aggregate the environmental data therefrom.

6. The media delivery system of claim 5 wherein the backend server is further configured to generate data indicative of a number of impressions for the rendering of media content from each of the plurality of environmental data servers.

7. The media delivery system of claim 1 wherein the backend server is configured to generate data indicative of at least one of human impressions, impression dwell time, tracking attention or length of time of attention.

8. The media delivery system of claim 1 wherein the environmental data server is configured to include data indicating transitions between and end and beginning of media content rendered by the media rendering device with the environmental data.

9. The media delivery system of claim 1 wherein the backend server is further configured to provide the media rendering device with rules governing rendering of media content by the media rendering device.

10. The media delivery system of claim 1 wherein environmental data server is included in the media rendering device.

11. A system for collecting impressions during rendering of media content by a media rendering device, comprising:
at least one environmental sensor configured to detect an environmental state proximate the media rendering device and generate signals in response thereto;
an environmental data server coupled to the at least one environmental sensor to receive the signals and configured to generate environmental data therefrom, the environmental data indicative of impressions occurring during rendering of media content; and
a backend server coupled to be in communication with the environmental data server to receive the environmental data, the backend server configured to correlate the environmental data to the rendered media content to provide impression data indicative of the number of impressions made during rendering of respective media content.

12. The system of claim 11 wherein the backend server is further configured to receive a playback history log of the rendering of media content by the media rendering device and correlate the impression data to the playback history log to calculate a number of impression made during the rendering of respective media content.

13. The system of claim 12 wherein the backend server is coupled to be in communication with the media rendering device and configured to receive the playback history log therefrom.

14. The system of claim 11, further comprising a sensor coupled to the environmental data server and configured to detect transitions between an end of a first media content and the beginning of a second media content and provide indication of the transition detection to the environmental data server.

15. The system of claim 11 wherein the environmental data server is coupled to be in communication with a time server providing time information to the media rendering device, the environmental data server configured to utilize the time information of the time server to synchronize with the media rendering device.

16. The system of claim 11 wherein the backend server is configured to be in communication with a plurality of environmental data servers and further configured to aggregate the environmental data from the plurality of environmental data servers.

17. The system of claim 16 wherein the backend server is configured to process the environmental data from the plurality of environmental data servers and monitor a count of impressions for a particular media content rendered on a plurality of different media rendering devices.

18. A method for collecting data indicative of a number of impressions made during rendering of media content by a media rendering device, the method comprising:
sensing at least one environmental state in proximity of the media rendering device during rendering of media content;
generating environmental data corresponding to detected environmental states;
providing the environmental data to a backend server;
processing the environmental data to provide impression data indicative of a number of impressions detected during rendering of the media content; and
correlating the impression data to rendering information associated with the media content to calculate a number of impressions made during rendering of respective media content.

19. The method of claim 18 wherein providing the environmental data to a backend server comprises providing the environmental data from a environmental data server coupled to a sensor located in proximity to the media rendering device.

20. The method of claim 18 wherein providing the environmental data to a backend server comprises providing the environmental data from the media rendering device.

21. The method of claim 18, further comprising receiving the rendering information at the backend server from the media rendering device.

22. The method of claim 18, further comprising detecting end-beginning transitions of the rendered media content and providing data indicative of the detected transitions to the backend server.

23. The method of claim 18, further comprising providing the environmental data to the media rendering device.

24. The method of claim 18, further comprising synchronizing time information related to the environmental data and the rendering of the media content.

25. The method of claim 24 wherein synchronizing time information comprises receiving time information from a common time server.
